(19) United States
(12) Patent Application Publication
(10) Pub. No.: US 2011/0135370 A1
(43) Pub. Date: Jun. 9, 2011

(54) PRINT DEVICE, TRANSPORT UNIT, TRANSPORT ROLLER AND METHOD OF PRODUCING THE TRANSPORT ROLLER

(75) Inventors: Kenji MATSUYAMA, Shiojiri-shi (JP); Kenji AOYAGI, Shiojiri-shi (JP); Ryoji UESUGI, Matsumoto-shi (JP); Koichi SAITO, Matsumoto-shi (JP)

(73) Assignee: SEIKO EPSON CORPORATION, Tokyo (JP)

(21) Appl. No.: 12/959,594

(22) Filed: Dec. 3, 2010

(30) Foreign Application Priority Data
Dec. 9, 2009 (JP) 2009-279833

(51) Int. Cl. B41J 13/02; B23P 19/04

(52) U.S. Cl. 400/578; 29/428

(57) ABSTRACT

A print device including a transport roller for transporting a recording medium in which a pair of end surfaces of a metallic plate faces each other so as to be molded in a cylindrical shape, wherein at least one end surface of the pair of end surfaces includes a first portion which comes into plane contact with the other end surface of the pair of end surfaces at an outer periphery surface side of the transport roller, and a second portion which has a gap between the second portion and the other end surface at an inner periphery surface side thereof.

### CROSS-REFERENCE TO RELATED APPLICATIONS

This application claims the benefit of priority to Japanese Patent Application No. 2009-279833 filed Dec. 9, 2009, the contents of which are hereby incorporated by reference in their entirety.

### BACKGROUND

1. Technical Field

The present invention relates to a print device, a transport unit, a transport roller, and a method of producing the transport roller.

2. Related Art

Hitherto, there has been used a print device which prints information to a sheet-shaped recording medium, and a transport unit for transporting the recording medium is provided on the print device. The transport unit has a transport roller for transporting the recording medium. A solid rod-shaped member is generally used in the transport roller. The recording medium is held in the transport roller and is transported by the rotation of the transport roller. Furthermore, since the printing is performed with respect to the recording medium together with the transportation, there is a need to transport the recording medium at a high accuracy and position the recording medium for a suitable printing.

On the other hand, there is a problem in that the solid material has increased in weight and cost, so that further weight and cost reductions are being considered. Herein, in JP-A-2006-289496, there is described a technique which bends a metallic plate so as to be molded in a cylindrical shape, thereby producing a hollow shaft.

However, when it is considered that the technique described in JP-A-2006-289496 is applied to a transport roller of a print device or the like, the following problem is generated.

In a case where the metallic plate is bent to mold a cylindrical transport roller, since an outer periphery requires a peripheral length longer than that of an inner periphery, a pair of end surfaces of a metallic plate comes into contact with each other in an inner periphery surface side thereof and a gap is formed in an outer periphery surface side. When the recording medium is transported using the transport roller, there is a fear that a step will be generated in the transport roller in the portion of the gap, which makes it impossible to perform the transportation and the positioning of the recording medium at a high accuracy.

### SUMMARY

An advantage of some aspects of the invention is to provide a print device that can transport an item to be transported such as a recording medium at a high accuracy, a transport unit, a transport roller and a method of providing the transport roller.

According to an aspect of the invention, there is adopted a configuration in which, in a print device including a transport roller for transporting a recording medium in which a pair of end surfaces of a metallic plate faces each other so as to be molded in a cylindrical shape, wherein at least one end surface of the pair of end surfaces includes a first portion which comes into plane contact with the other end surface of the pair of end surfaces at an outer periphery surface side of the transport roller, and a second portion which has a gap between the second portion and the other end surface at an inner periphery surface side.

According to the aspect of the invention, since the pair of end surfaces is in plane-contact with each other at the outer periphery surface side, a gap, a concave portion or the like which opens to the outer periphery surface side does not exist, and even if the transport roller rotates, the outer periphery surface is always in contact with the recording medium. Moreover, since the pair of end surfaces is in plane contact with each other, strength of the transport roller, particularly, strength in a joint of the pair of end surfaces is improved.

Moreover, it is preferable to adopt a configuration in which the pair of end surfaces includes the first portion and the second portion, and an angle formed by the second portion and the inner periphery surface is greater than 90° in any end surface.

Furthermore, it is preferable to adopt a configuration in which only one end surface includes the first portion and the second portion, and the angle formed by the second portion and the inner periphery surface is greater than 90°.

Moreover, it is preferable to adopt a configuration in which the first portion in the sectional surface of the metallic plate in a direction perpendicular to the end surface is shorter than the second portion in the sectional surface.

Furthermore, it is preferable to adopt a configuration in which the first portion and the second portion are provided on a place corresponding to a holding area of the recording medium at least in the transport roller.

Moreover, according to a further aspect of the invention, there is adopted a configuration in which, in a transport unit including a transport roller in which a pair of end surfaces of a metallic plate faces each other so as to be molded in a cylindrical shape, at least one end surface of the pair of end surfaces includes a first portion which comes into plane contact with the other end surface of the pair of end surfaces at an outer periphery surface side of the transport roller, and a second portion which has a gap between the second portion and one end surface at an inner periphery surface side.

Furthermore, according to a still further aspect of the invention, there is adopted a configuration in which, in a transport roller in which a pair of end surfaces of a metallic plate faces each other so as to be molded in a cylindrical shape, at least one end surface of the pair of end surfaces includes a first portion which comes into plane contact with one end surface of the pair of end surfaces at an outer periphery surface side, and a second portion which has a gap between the second portion and one end surface at an inner periphery surface side.

Moreover, according to a still further aspect of the invention, there is adopted a method of producing a transport roller in which a pair of end surfaces of a metallic plate faces each other so as to be molded in a cylindrical shape which includes the steps of forming a first portion which is connected to a one plate surface in a plate thickness direction of the metallic plate in at least one end surface of a pair of end surfaces, and a second portion which is connected to the other plate surface of an opposite side of the one plate surface and is different from the first portion; and bending the metallic plate so that the one plate surface becomes an outer periphery surface, thereby forming the metallic plate in a cylindrical shape, wherein, in the bending process, the first portion is brought into plane contact with one end surface of the pair of end surfaces, and a gap is formed between the second portion and the one end surface.

According to the aspect of the invention, since the pair of end surfaces is in plane-contact with each other at the outer periphery surface side, a gap, a concave portion or the like which opens to the outer periphery surface side is not formed, and even if the transport roller rotates, the outer periphery surface is always in contact with the recording medium. Moreover, since the pair of end surfaces is in plane-contact with each other, strength of the transport roller, particularly, strength in a joint of the pair of end surfaces is improved.

Moreover, it is preferable to adopt the method in which, in the forming process, the first portion and the second portion are formed in any of the pair of end surfaces, and an angle formed by the second portion and the other plate surface is greater than 90° in any end surface.

Furthermore, it is preferable to adopt the method in which, in the forming process, the first portion and the second portion are formed in only the one end surface, and an angle formed by the second portion and the other plate surface is greater than 90°.

Moreover, it is preferable to adopt the method in which, in the forming process, the first portion in the sectional surface of the metallic plate in a direction perpendicular to the end surface is formed so as to be shorter than the second portion in the sectional surface.

Furthermore, it is preferable to adopt the method in which, in the forming process, the first portion and the second portion are formed on a place of the end surface which corresponds to a holding area of the recording medium at least in the transport roller.

### BRIEF DESCRIPTION OF THE DRAWINGS

The invention will be described with reference to the accompanying drawings, wherein like numbers reference like elements.

FIG. 1 is an overall configuration diagram of a printer.

FIGS. 2A and 2B are schematic views showing configurations of a transport portion and a paper discharge portion.

FIGS. 3A to 3C are schematic views showing a configuration of a transport roller.

FIG. 4 is a schematic view showing a configuration of a second transport roller.

FIGS. 5A and 5B are flow charts showing processes for molding the transport roller.

FIG. 6 is a plane view of a large metallic plate.

FIG. 7 is a plane view of a metallic plate.

FIGS. 8A and 8B are sectional views showing a process of a punching machining.

FIG. 9 is a sectional view taken from lines IX-IX in FIG. 7 after a pair of end surfaces of the metallic plate is adjusted.

FIGS. 10A to 10C are schematic views showing a first half process of a bending machining relative to the metallic plate.

FIGS. 11A to 11C are schematic views showing a second half process of a bending machining relative to the metallic plate.

FIG. 12 is a schematic view showing a process of separating a roller main body from a frame portion.

FIG. 13A is a perspective view of the transport roller, and FIG. 13B is an end portion sectional view thereof.

FIG. 14A is a perspective view of an end portion of the roller main body and FIG. 14B is a front view thereof.

FIG. 15A is a perspective view of an end portion of the roller main body and FIG. 15B is a front view thereof.

FIG. 16A is a perspective view of an end portion of the roller main body and FIG. 16B is a front view thereof.

FIGS. 17A to 17D are plane views of the metallic plate showing a deploying engagement portion.

FIGS. 18A to 18C are plane views of the metallic plate showing a deploying engagement portion.

FIGS. 19A and 19C are plane views showing shapes of a joint of the roller main body, and FIG. 19B is a plane view of a metallic plate.

FIG. 20A is a plane view showing shapes of a joint of the roller main body, and FIG. 20B is a plane view of a metallic plate.

FIG. 21A is a plane view showing shapes of a joint of the roller main body, and FIG. 21B is a plane view of a metallic plate.

FIG. 22 is a perspective view showing a relationship of the transport roller and a recording paper P during transportation.

FIGS. 23A to 23C are plane views showing shapes of the joint of the roller main body.

FIGS. 24A to 24C are plane views showing shapes of the joint of the roller main body.

FIG. 25A is a plane view of the transport roller, FIG. 25B is a sectional view taken from lines XXVB-XXVB in FIG. 25A, and FIG. 25C is a plane view showing a modified example of an opening.

### DESCRIPTION OF EXEMPLARY EMBODIMENTS

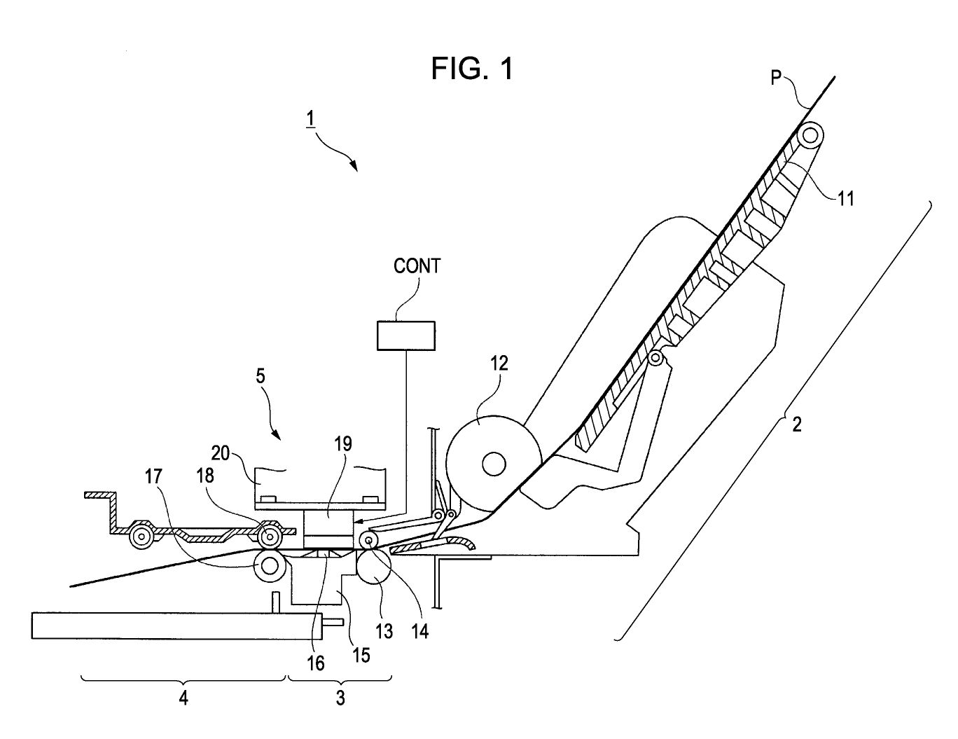

Hereinafter, an embodiment of the invention will be described with reference to FIGS. 1 to 25. In the respective drawings used in the following description, scale of each member is suitably changed to make each member recognizable size. In the following description, as a print device, an example of an ink jet type printer (hereinafter, merely referred to as “printer”), which ejects ink to a paper or the like that is a recording medium to record information such as letters or images, will be described.

A configuration of a printer 1 according to the present embodiment will be described with reference to FIG. 1.

FIG. 1 is an overall configuration diagram of the printer 1 according to the present embodiment.

The printer (print device) 1 is a print device which ejects ink to a recording paper P that is a recording medium, thereby recording information such as letters or images. The printer 1 has a paper feeding portion 2, a transport portion (a transport unit) 3, a paper discharge portion 4, a head portion 5, and a control portion CONT.

The paper feeding portion 2 holds the recording paper P and supplies the recording paper P toward the transport portion 3, and has a paper tray 11 and a paper feeding roller 12. The paper tray 11 holds a plurality of recording papers P. As the recording paper P, a recording medium of a sheet shape that can be printed by ink is used, and normal paper, coated paper, a sheet for an OHP (an overhead projector), glossy paper, glossy film or the like are used.

The paper feeding roller 12 is a roller which supplies the recording paper P toward the transport portion 3 by being rotated, and is provided on the transport portion 3 side of the paper tray 11. In addition, a separation pad (not shown) is provided at a position facing an outer periphery surface of the paper feeding roller 12, so that the separation pad cooperates with the paper feeding roller 12 and can supply the recording paper P to the transport portion 3 one sheet at a time.

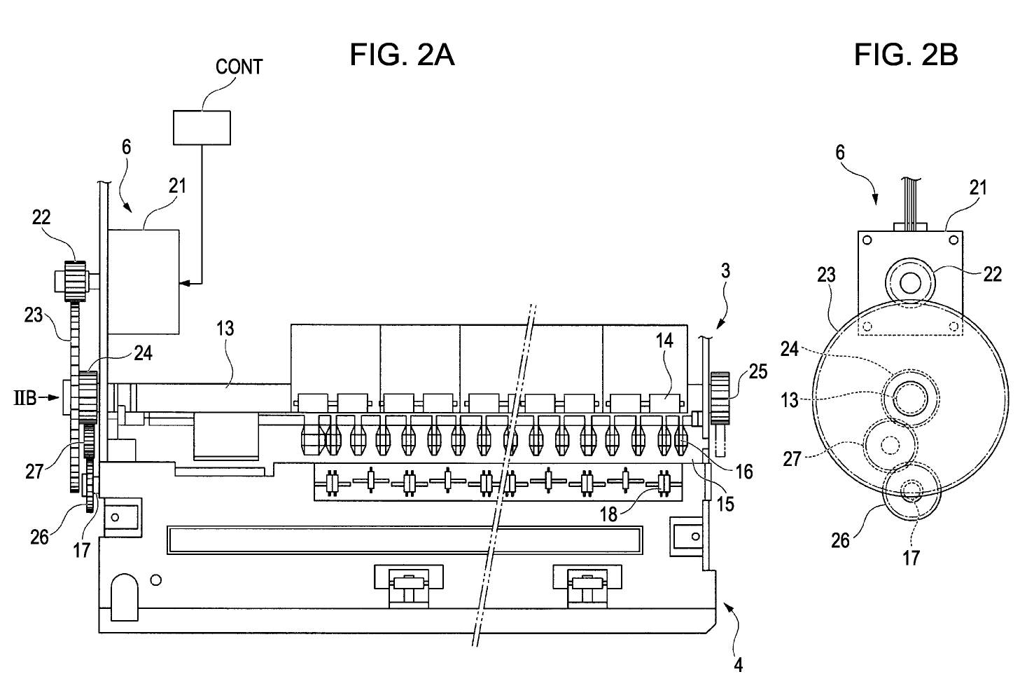

The transport portion 3 transports the recording paper P, which has been supplied from the paper feeding portion 2, toward the paper discharge portion 4 and is a place where the printing operation relative to the recording paper P is performed. The transport portion 3 has a transport roller 13, a driven roller 14, a platen 15, a diamond rib 16, and a driving portion 6 (see FIGS. 2A and 2B).

The transport roller 13 is a roller for accurately transporting the recording paper P to a predetermined printing position by being rotated, and is a shaft member which extends to a direction going directly to a paper feeding direction of the paper feeding portion 2 and in a horizontal direction and is molded in the form of a cylinder. The transport roller 13 is rotatably supported by a pair of bearings (not shown) having an approximate U shape which is provided on the transport portion 3 and is rotated by the driving of the driving portion 6. In addition, the details of the transport roller 13 will be described later.

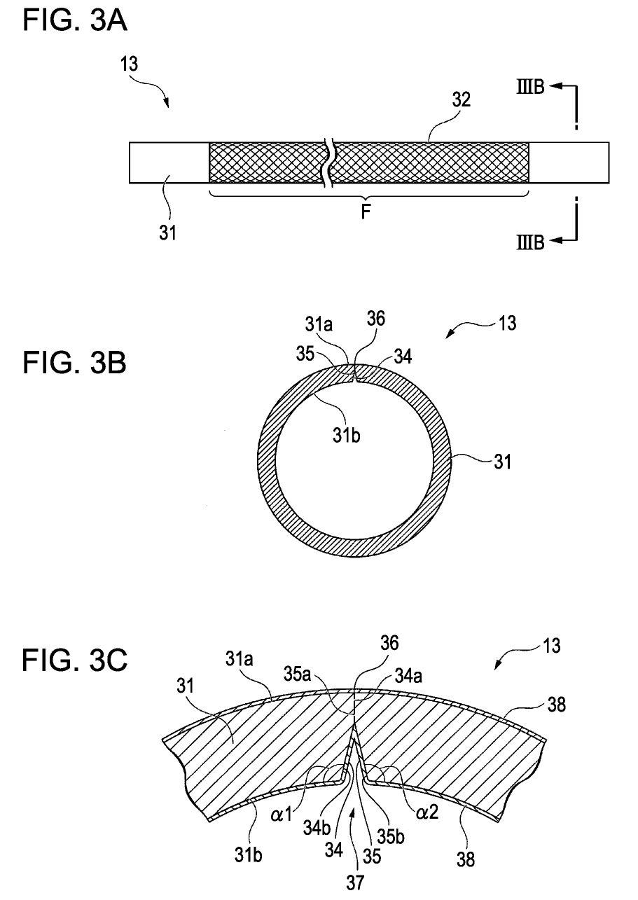

The driven roller 14 is an approximately cylindrical member and a plurality of driven rollers 14 is disposed at intervals along an axial direction of the transport roller 13. Furthermore, the driven roller 14 is rotatably provided at a position facing a high frictional layer 32 (see FIG. 3) of the transport roller 13 as described later. A pressing spring (not shown) is provided on the driven roller 14, so that the driven roller 14 is pressed to and comes in contact with the high frictional layer 32 of the transport roller 13 by the pressing force of the pressing spring. For this reason, the driven roller 14 can rotate to follow the rotation of the transport roller 13, whereby the recording paper P can be pinched between the driven roller 14 and the transport roller 13. In addition, at the outer periphery surface of the driven roller 14, in order to relieve abrasion and damage due to the sliding with the high frictional layer 32, for example, a low abrasion treatment such as a fluororesin coating is carried out.

The platen 15 is a place for supporting the recording paper P from a lower part when the printing to the recording paper P by the head portion 5 is carried out, and has a surface which is approximately parallel to a horizontal surface. The diamond rib 16 is a protruding portion which protrudes from an upper surface of the platen 15 toward the upper part, and a plurality of diamond ribs 16 is disposed at intervals along an axial direction of the transport roller 13. Furthermore, a top surface of the diamond rib 16 is formed to be approximately parallel with the horizontal surface, the recording paper P during printing is supported from the lower part by the top surface.

The paper discharge portion 4 discharges the recording paper P after printing form the transport portion 3 and has a paper discharge roller 17 and a paper discharge coarse roller 18. The paper discharge roller 17 and the paper discharge coarse roller 18 can rotate in opposite directions to each other, whereby the recording paper P is taken out and discharged by the rotation.

The head portion 5 ejects ink with respect to the recording paper P mounted on the transport portion 3, and has an ejection head 19 and a carriage 20. The ejection head 19 is equipment that ejects ink in accordance with instructions of the control portion CONT, and an ejection port (not shown) thereof is provided to face the top surface of the diamond rib 16. The carriage 20 holds the ejection head 19 at a lower side thereof and is provided movably back and forth in the axial direction of the transport roller 13. Furthermore, a driving portion (not shown) for reciprocating the carriage 20 in accordance with instructions of the control portion CONT is connected to the carriage 20.

Next, a configuration for rotating the transport roller 13 will be described with reference to FIG. 2.

FIG. 2 is a schematic view showing configurations of the transport portion 3 and the paper discharge portion 4, FIG. 2A is a plane view and FIG. 2B is a perspective view shown from arrow IIB in FIG. 2A.

As described above, the transport portion 3 has the driving portion 6. The driving portion 6 rotates the transport roller 13 and has a motor 21 and a pinion gear 22. The motor 21 is an electric motor that rotates the transport roller 13 in accordance with instructions of the control portion CONT. The control portion CONT controls the rotation of the transport roller 13 by controlling the rotation of the motor 21, so that the control portion CONT has a configuration capable of transporting the recording paper P at a high positioning accuracy. The pinion gear 22 is a gear that is integrally connected with an output shaft of the motor 21.

On the transport roller 13, a first drive gear 23, a second drive gear 24 and a third drive gear 25 are mounted. The first drive gear 23 is a gear for rotating the transport roller 13 and is integrally mounted on an end portion of the driving portion 6 installation side in the transport roller 13 by a press-fit. The first drive gear 23 is configured so as to be engaged with the pinion gear 22, so that the driving force of the motor 21 is transmitted to the transport roller 13 via the pinion gear 22 and the first driving gear 23, thereby rotating the transport roller 13.

The second drive gear 24 is a gear for transmitting the driving force of the motor 21 to the paper discharge roller 17, has a diameter smaller than the first drive gear 23, and is moved adjacent to and integrally fixed to the first drive gear 23. Furthermore, the second drive gear 24 is integrally mounted on the transport roller 13 by the press-fit.

The third drive gear 25 is a gear for transmitting the rotational driving force of the transport roller 13 to another instrument (not shown) and is integrally connected to an end portion of a side opposite to the first drive gear 23 of the transport roller 13 by press-fitting. In addition, a configuration may be adopted in which the third drive gear 25 rotates synchronously with the transport roller 13 by providing a rotation stop portion (a pin or a recess portion) at each of the transport roller 13 and the third drive gear 25 without the use of the press-fit.

A paper discharge drive gear 26 is integrally mounted on the end portion of the driving portion 6 side in the paper discharge roller 17. A middle gear 27 is provided between the paper discharge drive gear 26 and the second drive gear 24, and the middle gear 27 is engaged with the second drive gear 24 and the paper discharge drive gear 26, respectively. That is, it is configured such that the driving force of the motor 21 is transmitted to the paper discharge roller 17 via the second drive gear 24, the middle gear 27 and the paper discharge drive gear 26, thereby rotating the paper discharge roller 17.

Next, a configuration of the transport roller 13 will be described with reference to FIGS. 3A to 3C.

FIGS. 3A to 3C are schematic views showing the configuration of the transport roller 13, FIG. 3A is a side view thereof, FIG. 3B is a sectional view taken from lines IIIB-IIIB in FIG. 3A, and FIG. 3C is an enlarged view in the vicinity of a joint 36 in FIG. 3B. The transport roller 13 is a shaft member molded in the form of a cylinder and has the roller main body 31 and the high frictional layer 32.

The roller main body 31 is a shaft member in which a metallic plate having approximately regular plate thickness is bent so as to be molded in the form of a cylinder. A steel plate is used as the metallic plate, but a metallic plate such as aluminum or stainless steel may be used. The roller main body 31 has a joint 36 on which a first end surface (end surface) 34 and a second end surface (end surface) 35, which are a pair of end surfaces of the metallic plate, come into contact with each other. The joint 36 extends in parallel with a center axis direction of the roller main body 31.

A first end surface outer edge portion (a first portion) 34a, which is connected to an outer periphery surface (one first plate surface) 31a of the roller main body 31, and a first end surface inner edge portion (a second portion) 34b which is connected to an inner periphery surface (the other plate surface) 31b of the roller main body 31 are formed in the first end surface 34. The first end surface outer edge portion 34a and the first end surface inner edge portion 34b are formed all over the length of the roller main body 31. A second end surface outer edge portion (a first portion) 35a connected with the outer periphery surface 31a and a second end surface inner edge portion (a second portion) 35b connected with the inner periphery surface 31b are formed in the second end surface 35. The second end surface outer edge portion 35a and the second end surface inner edge portion 35b are formed all over the length of the roller main body 31.

The first end surface outer edge portion 34a and the second end surface outer edge portion 35a are in plane-contact with each other. That is, in the joint 36, a gap, a concave portion or the like that opens to the outer periphery surface 31a side does not exist. Thus, it is possible to always maintain the contact of the outer periphery surface 31a and the recording paper P when the transport roller 13 rotates. Furthermore, since the first end surface outer edge portion 34a and the second end surface outer edge portion 35a are in plane-contact with each other, strength of the roller main body 31, in particular, strength in the vicinity of the joint 36 is improved. Even if a bending or twisting force is applied to the roller main body 31, it is possible to prevent the first end surface 34 and the second end surface 35 from being separated from each other.

A gap 37 is formed between the first end surface inner edge portion 34b and the second end surface inner edge portion 35b. The gap 37 has a shape in which the width gradually becomes wider as it faces toward the inner periphery surface 31b side. A first angle α1, which is formed by the first end surface inner edge portion 34b and the inner periphery surface 31b, and a second angle α2, which is formed by the second end surface inner edge portion 35b and the inner periphery surface 31b, are greater than 90°.

As described later, in both of a pair of end surfaces 34 and 35 of the present embodiment, an end surface adjustment machining is carried out. For that reason, for example, even when a stress or the like due to the machining is generated in the vicinity of the end surfaces 34 and 35, since the stress is generated in any of the end surfaces 34 and 35, it is possible to suppress the distortion, the deformation or the like caused by non-uniformity of the stress, in the transport roller 13 (the roller main body 31) which is molded by bending the metallic plate.

The roller main body 31 has a plating layer 38 formed on the surface thereof. The plating layer 38 is formed on the surfaces of the outer periphery surface 31a and the inner periphery surface 31b, and the first end surface inner edge portion 34b and the second end surface inner edge portion 35b. The plating layer 38 may be formed by the use of any method of an electric field plating and an electroless plating, and may be formed by overlapping a plurality of plating layers. As a type of plating, for example, a nickel plating, a zinc plating, a chromium plating or the like is used.

The high frictional layer 32 is a coating layer which is formed on the outer periphery surface 31a other than both end portions of the roller main body 31, thereby improving a frictional coefficient between the high frictional layer 32 and the recording paper P to reliably hold the recording paper P. In order to transport the recording paper P at a high positioning accuracy, since the transport roller 13 needs to hold the recording paper P without slipping, the high frictional layer 32 is formed on a holding area F of the outer periphery surface 31a which is an area where the recording paper P is held during transportation.

The high frictional layer 32 has a resin layer formed of epoxy-based resin, polyester-based resin or the like, and ceramic particles which are dispersed and disposed on the resin layer surface. Aluminum oxide (alumina), silicon carbide, silicon dioxide or the like is used in the ceramic particles. The particle diameter of the ceramics particles is regulated by a crushing treatment, and the ceramics particles have sharp end surfaces by performing the crushing treatment, whereby the frictional coefficient between the ceramics particles and the recording paper P can be improved. In addition, instead of the high frictional layer 32, the frictional coefficient between the ceramics particles and the recording paper P may be improved by forming minute concave and convex portions (a vanishing treatment or the like) on the outer periphery surface 31a.

In addition, in the configuration shown in FIGS. 3A to 3C, both of the outer edge portions 34a and 35a and the inner edge portions 34b and 35b are formed all over the length of the roller main body 31, but they may be formed only in a place corresponding to the holding area F of the recording paper P. As described later, the outer edge portions 34a and 35a and the inner edge portions 34b and 35b are formed by regulating the first end surface 34 and the second end surface 35. However, the stress generated in the vicinity of the end surfaces 34 and 35 is reduced by limiting the range of the machining, which makes it possible to suppress the distortion or the deformation of the roller main body 31. Furthermore, it is desirable that forming areas of the outer edge portions 34a and 35a and the inner edge portions 34b and 35b be areas which are slightly expanded from the holding area F to both end sides of the roller main body 31. This is for the purpose of uniformizing a change in shape or the stress generated in the vicinity of the end surfaces 34 and 35 in the axial direction, at least within the holding area F.

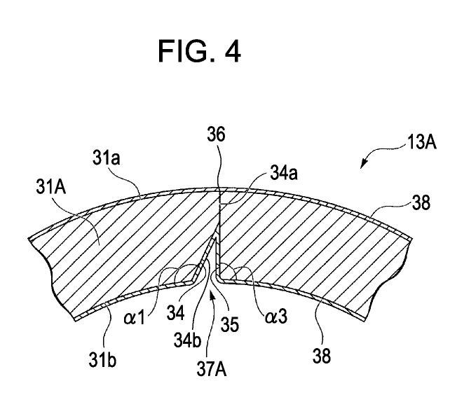

In addition, instead of the transport roller 13 as described above, a second transport roller (transport roller) 13A which is a modified example thereof may be used. The second transport roller 13A, which is a modified example of the transport roller 13, will be described with reference to FIG. 4.

FIG. 4 is a schematic view of a configuration of the second transport roller 13A. In addition, FIG. 4 corresponds to FIG. 3C, and the same elements as the constituents shown in FIG. 3 will be denoted by the same reference numerals and their description will be omitted.

The second transport roller 13A is a modified example of the transport roller 13. The second transport roller 13A has a second roller main body 31A and a high frictional layer 32. The second roller main body 31A is a shaft member in which a metallic plate having regular plate thickness has been bent so as to be molded in the form of a cylinder, and has a joint 36 on which a first end surface 34 and a second end surface 35, which are a pair of end surfaces of the metallic plate, come into contact with each other. On the first end surface 34, a first end surface outer edge portion 34a and a first end surface inner edge portion 34b are formed. On the other hand, the second end surface 35 faces the first end surface 34, and is formed to have an approximately plane which is approximately parallel to a diameter direction of the second roller main body 31A.

The first end surface outer edge portion 34a is in plane-contact with the second end surface 35. That is, a gap or a concave portion, which opens to the outer periphery surface 31a side, does not exist in the joint 36. Thus, it is possible to always hold the contact of the outer periphery surface 31a and the recording paper P when the second transport roller 13A rotates. Furthermore, since the first end surface outer edge portion 34a and the second end surface 35 are in plane-contact with each other, the strength of the second roller main body 31A, particularly, the strength in the vicinity of the joint 36 is improved. Even if bending or twisting force is applied to the second roller main body 31A, it is possible to prevent the first end surface 34 and the second end surface 35 being separated from each other.

A second gap (gap) 37A is formed between the first end surface inner edge portion 34b and the second end surface 35. The second gap 37A has a shape in which the width thereof gradually becomes wider as it faces the inner periphery surface 31b side. A first angle α1 formed by the first end surface inner edge portion 34b and the inner periphery surface 31b is greater than 90°, and a third angle α3 formed by the second end surface 35 and the inner periphery surface 31b is equal to or less than 90°. That is, the first end surface 34 (and a second end surface 35) in the joint 36 has a shape that inclines in a predetermined direction in regard to a circumferential direction. When the second transport roller 13A is rotated in the direction along the inclination to transport the recording paper P, even if pressing force due to the transportation is added with respect to the joint 36, the separation of the first end surface 34 and the second end surface 35 hardly occurs. Thus, it is possible to suppress the distortion, the deformation or the like of the second transport roller 13A which may be generated due to the transportation.

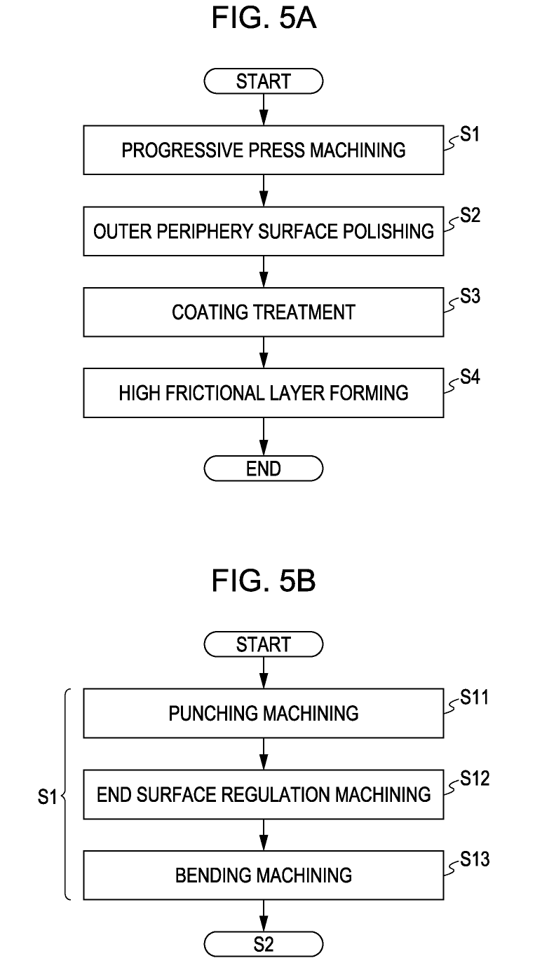

Next, a method of molding the transport roller 13 will be described with reference to FIGS. 5 to 12.

FIGS. 5A and 5B are flow charts showing a process of molding the transport roller 13, FIG. 5A is an overall flow chart, and FIG. 5B is a detailed flow chart of a progressive press machining in FIG. 5A.

As shown in FIG. 5A, firstly, an outline of the molding process of the transport roller 13 molds a cylindrical roller main body 31 from a large metallic plate as a material by the progressive press machining (machining that consecutively performs the punching machining and the press machining) (step S1).

As shown in FIG. 5B, firstly, details of the progressive press machining of step S1 mold an approximately rectangular metallic plate from the large metallic plate by the punching machining (step S11). Next, an end surface regulation machining for regulating the first end surface 34 and the second end surface 35, which are a pair of end surfaces of the metallic plate (step S12), by the press machining is performed. Finally, the metallic plate is bent in the form of a cylinder by the bending machining which uses the press machining, thereby molding the roller main body 31 (step S13).

Next, as shown in FIG. 5A, the outer periphery surface of the roller main body 31 is polished (centerless polishing), thereby regulating diameter thereof, roundness, and bent state (step S2). Next, the plating treatment is applied to the surface of the roller main body 31, thereby forming the plating layer 38 (step S3). Finally, the high frictional layer 32 is formed on the outer periphery surface 31a of the roller main body 31 (step S4). As described above, the molding of the transport roller 13 is completed. In the following description, the step S1, which is a process for molding the roller main body 31 from the large metallic plate by the progressive press machining, will be particularly described.

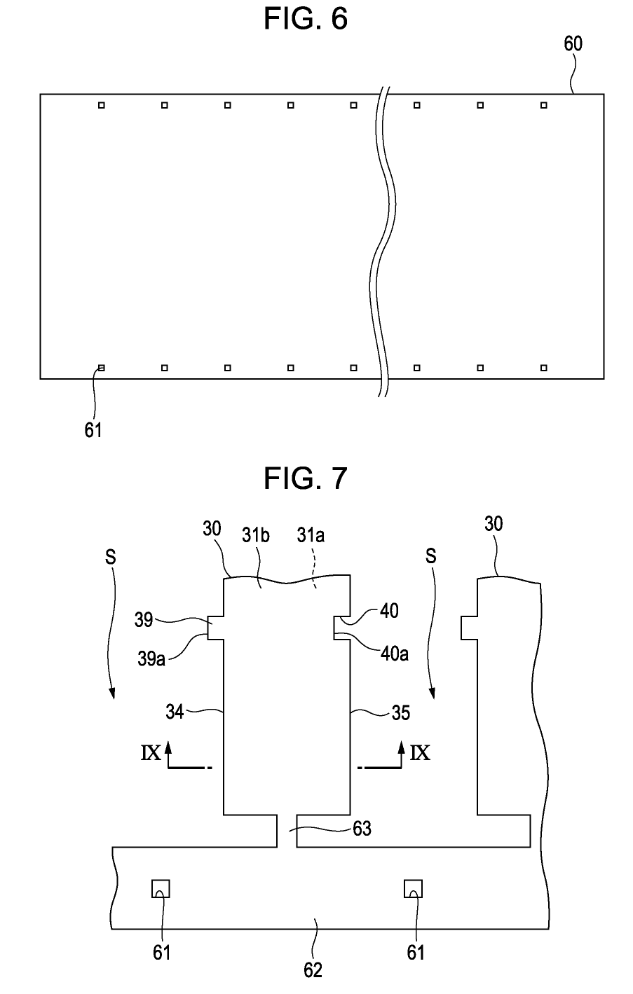

The process (step S1) for molding the roller main body 31 from the large metallic plate by the progressive press machining will be described with reference to FIGS. 6 to 12.

FIG. 6 is a plane view of the large metallic plate 60 becoming a material of the roller main body 31.

FIG. 7 is a plane view of the metallic plate 30.

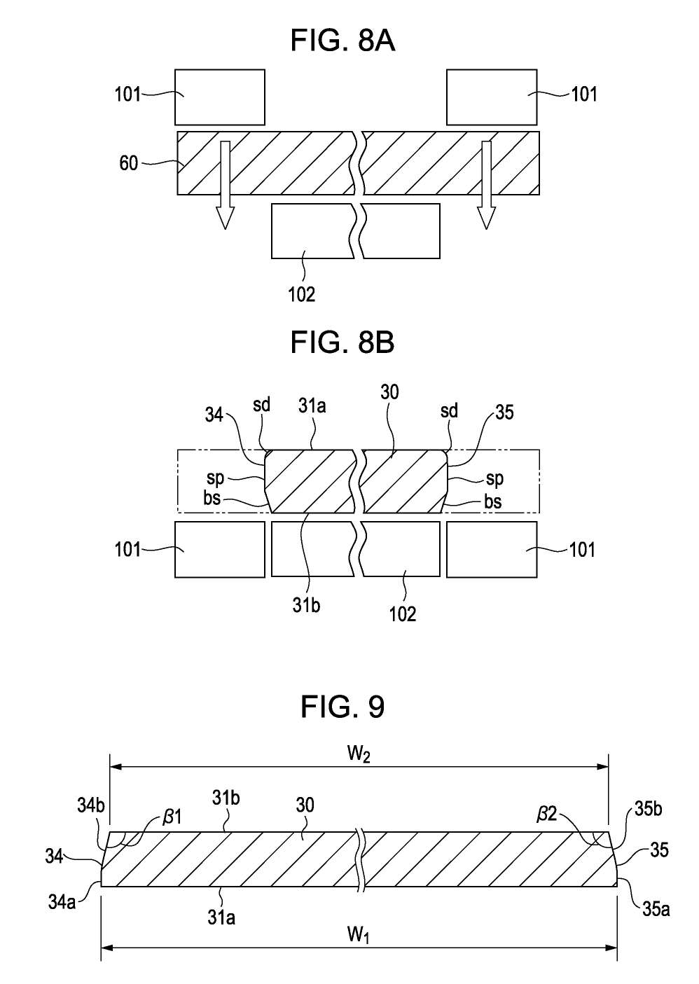

FIGS. 8A and 8B are sectional views showing a process of a punching machining.

FIG. 9 is a sectional view taken from lines IX-IX in FIG. 7 after a pair of end surfaces of the metallic plate 30 is adjusted.

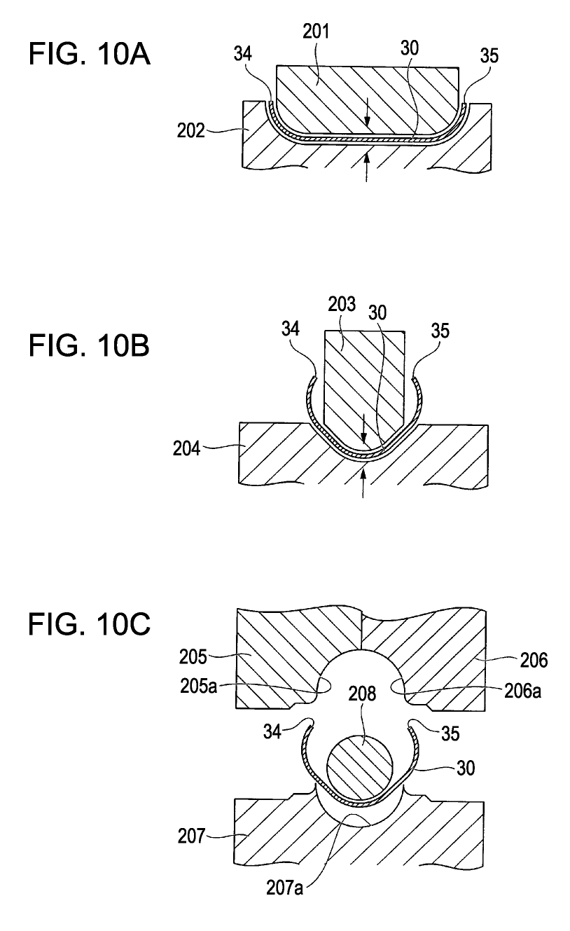

FIGS. 10A to 10C are schematic views showing a first half process of a bending machining relative to the metallic plate 30.

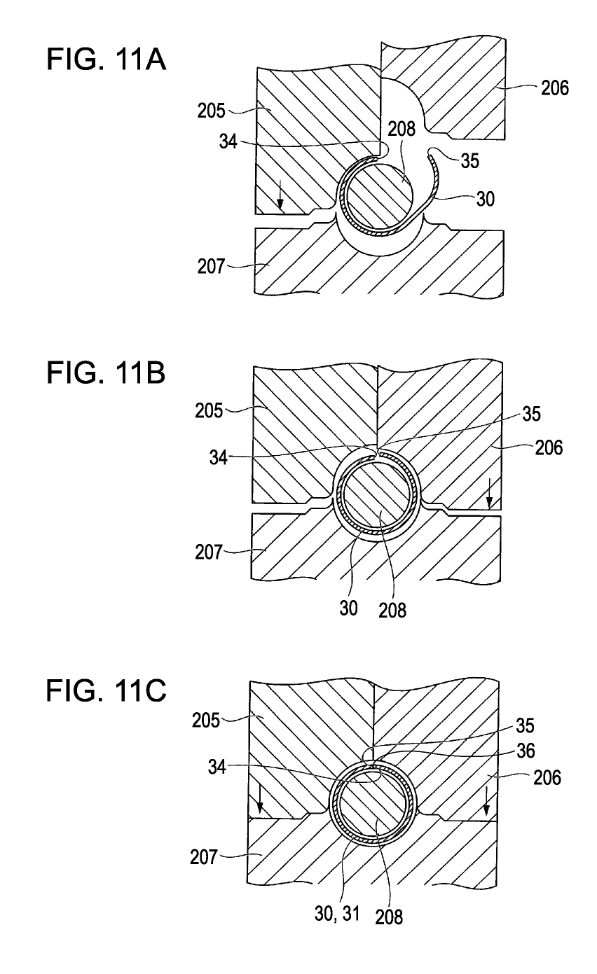

FIGS. 11A to 11C are schematic views showing a second half process of a bending machining relative to the metallic plate 30.

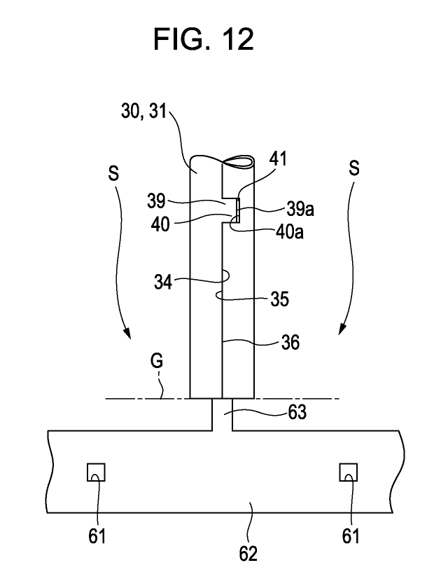

FIG. 12 is a schematic view showing a process of separating the roller main body 31 from the frame portion 62.

In the molding of the roller main body 31 in the present embodiment, the progressive press machining is used.

This machining method is a method of sequentially carrying out a punching machining and a press machining with respect to the metallic plate, while transporting the metallic plate which is the material at a regular pitch.

Firstly, the large metallic plate 60 as shown in FIG. 6 is prepared. The large metallic plate 60 is an approximately rectangular steel plate having a thickness of approximately 1 mm, and is produced using an electric zinc plating steel plate (SECC) or a cold-drawn steel plate (SPCC). At a pair of edge portions of the large metallic plate 60 in a paper up and down direction, a plurality of opening portions 61 is provided along the edge portions at predetermined gaps. The opening portions 61 are used for transporting the large metallic plate 60 at regular pitches when the progressive press machining is performed with respect to the large metallic plate 60, and the large metallic plate 60 is transported for each gap of the adjacent opening portions 61.

Next, as shown in FIG. 7, an approximately rectangular metallic plate 30 is molded from the large metallic plate 60, by the punching machining (step S11) in the progressive press machining (step S1). That is, the portion of the area S is punched from the large metallic pate 60, thereby molding the metallic plate 30 and the frame portion 62. The metallic plate 30 is an approximately band-shaped rectangular metallic plate, which extends in a direction (the paper up and down direction) and a progressive direction of the large metallic plate 60, and is molded by the removal of the portion of the area S from the large metallic plate 60. In addition, since plate surfaces of both sides in a plate thickness direction in the metallic plate 30 become inner and outer periphery surfaces of the roller main body 31, the plate surfaces are hereinafter conveniently referred to as the outer periphery surface 31a and the inner periphery surface 31b. In FIG. 7, the paper surface side of the metallic plate 30 is referred to as the inner periphery surface 31b, and the paper rear side is referred to as the outer periphery surface 31a.

The first end surface 34 and the second end surface 35, which are a pair of end surfaces of the metallic plate 30 in a direction perpendicular to the extending direction, are places where they come into contact with each other to form the joint 36 when the metallic plate 30 is molded in the form of a cylinder. In addition, both of the first end surface 34 and the second end surface 35 after the punching machining are perpendicular to the outer periphery surface 31a or the inner periphery surface 31b and both of the outer periphery surface 31a and the inner periphery surface 31b have the same width.

A convex portion 39 and a concave portion 40 are respectively formed on the first end surface 34 and the second end surface 35. The convex portion 39 and the concave portion 40 are for preventing a difference in the extending direction of the first end surface 34 and the second end surface 35 by the fitting of the convex portion 39 into the concave portion 40. A front end portion 39a of the convex portion 39 and a bottom portion 40a of the concave portion 40 are formed in parallel to the extending direction of the metallic plate 30.

The frame portion 62 is an approximately band-shaped plate portion which extends in a direction approximately perpendicular to the extending direction of the metallic plate 30, and is molded by the removal of the portion of the area S from the large metallic plate 60. The above-mentioned opening portions 61 are arranged in a row on the frame portion 62. A connecting portion 63 (commonly known as a tie bar) connecting the metallic plate 30 and the frame portion 62 each other spans between the metallic plate 30 and the frame portion 62, and the metallic plate 30 is supported by the frame portion 62 via the connecting portion 63.

In addition, it is desirable that a broken surface or a burr, which is formed on the end surface (a cutting surface) of the metallic plate 30 at the time of punching machining, be disposed at the inner side of a bending direction in the bending machining as described later.

The metallic plate 30 is molded from the large metallic plate 60 by the punching machining as shown in FIGS. 8A and 8B. Firstly, as shown in FIG. 8A, at both sides of the plate thickness direction of the large metallic plate 60, a male mold 101 and a female mold 102 which are molds for the punching machining are disposed respectively. Next, as shown in FIG. 8B, the male mold 101 is moved to the female mold 102 side, thereby cutting the large metallic plate 60 using the molds to mold the metallic plate 30.

On the cutting surface of the metallic plate 30, namely, the first end surface 34 and the second end surface 35, a lax portion sd, a shear surface sp, a broken surface bs and a burr (not shown) are often formed. Herein, the surface of the paper upper side connected to the relatively smooth lax portion sd is called the outer periphery surface 31a, and the surface of the paper lower side, which is connected to the cutting surface bs and in which the burr may be generated, is called the inner periphery surface 31b. By bending the metallic plate 30 in this direction, the broken surface bs or the burr is obstructed when the roller main body 31 is molded, whereby it is possible to prevent the first end surface 34 and the second end surface 35 from being separated from each other.

Moreover, by bending the metallic plate 30 in the direction to bring the first end surface 34 and the second end surface 35 into contact with each other, the broken surface bs or the burr is provided at the inner side of the roller main body 31, whereby it is possible to prevent them from protruding from the outer periphery surface 31a. For that reason, it is possible to omit a deburring process, thereby improving the productivity of the roller main body 31.

Next, an end surface regulation machining (step S12) is carried out with respect to the first end surface 34 and the second end surface 35 of the metallic plate 30.

As shown in FIG. 9, the first end surface 34 and the second end surface 35 are regulated by the press machining, thereby forming the first end surface outer edge portion 34a and the first end surface inner edge portion 34b on the first end surface 34, and forming the second end surface outer edge portion 35a and the second end surface inner edge portion 35b on the second end surface 35. In addition, the first end surface outer edge portion 34a and the first end surface inner edge portion 34b are surfaces which are different from each other, and the second end surface outer edge portion 35a and the second end surface inner edge portion 35b are surfaces which are different from each other.

Herein, although it is not particularly limited, in the present embodiment, the first end surface outer edge portion 34a in the sectional surface of the metallic plate 30 shown in FIG. 9 is regulated so as to be shortened with respect to the first sectional surface inner edge portion 34b in the same end surface. By the regulation in this manner, the metallic plate 30 is more reliably prevented from contacting at the inner periphery surface, whereby it possible to make the surface accuracy of the transport roller 13 higher. In addition, the second sectional surface outer edge portion 35a in the end surface of the metallic plate 30 shown in FIG. 9 may be regulated so as to be shortened with respect to the second end inner edge portion 35b in the same sectional surface.

The first end surface inner edge portion 34b and the second end surface inner edge portion 35b have approximately plane shapes, respectively. By the regulation, a first angle β1 at the time when the flat plate is formed by the first end surface inner edge portion 34b and the inner periphery surface 31b and a second angle β2 at the time when the flat plate is formed by the second end surface inner edge portion 35b and the inner periphery surface 31b are greater than 90°.

Furthermore, by carrying out the end surface regulation machining, an outer periphery surface width W₁, which is a length in a width direction of the outer periphery surface 31a, is greater than an inner periphery surface width W₂ which is a length in the width direction of the inner periphery surface 31b. For that reason, when the metallic plate 30 is bent to mold the cylindrical roller main body 31, it is possible to easily bring the first end surface outer edge portion 34a and the second end surface outer edge portion 35a into plane-contact with each other.

In the end surface regulation machining of the present embodiment, the machining is carried out with respect to any of the first end surface 34 and the second end surface 35. For this reason, for example, even when the stress or the like due to the machining is generated in the vicinity of the first end surface 34 and the second end surface 35, since the stress is generated in any of a pair of end surfaces 34 and 35, it is possible to suppress the distortion, the deformation or the like caused by the non-uniformity of the stress in the transport roller 13 (the roller main body 31) molded by bending the metallic plate 30.

In addition, the above-mentioned end surface regulation machining may be carried out only in any one of the first end surface 34 and the second end surface 35. By the regulation in this manner, the second roller main body 31A shown in FIG. 4 can be molded.

Furthermore, the above-mentioned end surface regulation machining may be carried out only in the place corresponding to the holding area F shown in FIGS. 3A and 3B.

Next, the bending machining (step S13) in the progressive press machining shown in FIGS. 10 and 11 is carried out with respect to the metallic plate 30, thereby molding the metallic plate 30 in the form of a cylinder. In addition, FIGS. 10 and 11 are sectional views taken from lines X-X and XI-XI in FIG. 7.

Firstly, as shown in FIG. 10A, a first male mold 201 and the first female mold 202 press the metallic plate 30, thereby bending the both edge portions in the width direction of the metallic plate 30 approximately in the form of a circular arc. In addition, in FIG. 10A, the gap is respectively formed among the metallic plate 30, the first male mold 201 and the first female mold 202. However, in practice, no gap exists, and the metallic plate 30, the first male mold 201 and the first female mold 202 are in close contact with each other. This is also true for FIGS. 10B and FIGS. 11A to 11C.

Next, as shown in FIG. 10B, a second male mold 203 and a second female mold 204 press the metallic plate 30, thereby bending a center portion in the width direction of the metallic plate 30 approximately in the form of a circular arc. By the bending machining, the sectional surface shape of the metallic plate 30 becomes approximately a C shape which opens to the second male mold 203 side.

Next, as shown in FIG. 10C, the metallic plate 30, which has been molded in the form of approximately C shape when seen in cross-section, is disposed among a first upper mold 205, a second upper mold 206 and a lower mold 207. A cylindrical core 208 is disposed at the inner side of the metallic plate 30. Herein, each of press surfaces 205a, 206a and 207a of the first upper mold 205, the second upper mold 206 and the lower mold 207 has a shape that corresponds to the outer periphery surface 31a of the roller main body 31 to be molded. Furthermore, the outer periphery surface of the core 208 has a shape that corresponds to the inner periphery surface 31b of the roller main body 31 to be molded. In addition, the first upper mold 205 and the second upper mold 206 can move independently from each other.

Next, as shown in FIG. 11A, in the state of stopping the core 208, the first upper mold 205 is moved toward the lower mold 207 to press the first end surface 34 side of the metallic plate 30, thereby bending it approximately in the form of a semicircle. In addition, in the same manner as the first upper mold 205 and the second upper mold 206, the lower mold 207 is made to be a pair of division molds, and during the process shown in FIG. 11A, the lower mold of the same side as the first upper mold 205 may be moved toward the first upper mold 205.

Next, as shown in FIG. 11B, the core 208 is slightly moved toward the lower mold 207, and the second upper mold 206 is moved toward the lower mold 207 to press the second end surface 35 side of the metallic plate 30, thereby bending it approximately in the form of a semicircle.

Next, as shown in FIG. 11C, the first upper mold 205, the second upper mold 206 and the core 208 are moved toward the lower mold 207, thereby pressing the metallic plate 30. At this time, the first upper mold 205 and the second upper mold 206 are in contact with the lower mold 207. By the pressing, the metallic plate 30 is molded approximately in the form of a cylinder, so that the roller main body 31 is molded from the metallic plate 30. In addition, in the process, the first end surface outer edge portion 34a and the second end surface outer edge portion 35a of the metallic plate 30 come into plane contact with each other. On the other hand, a gap 37 is formed between the first end surface inner edge portion 34b and the second end surface inner edge portion 35b.

In addition, since the roller main body 31 (the transport roller 13) is molded by the use of the large metallic plate 60 in which the winding due to the steel plate coil remains, it is desirable to mold the surface at inner periphery side of the coil so as to be the inner periphery surface of the roller main body 31. That is, the winding of the large metallic plate 60 by the steel plate coil is in a bent state in which the surface at the inner periphery surface of the steel plate coil becomes the concave surface. That is, in the large metallic plate 60 that molds the roller main body 31, the winding, which is bent to the inner periphery side of the roller main body 31, remains.

For this reason, the winding does not act, at least in a direction of opening the joint 36 of the roller main body 31. Thus, as compared to a case where the winding which is bent to the outer periphery side of the roller main body 31 remains, the joint 36 of the roller main body 31 can be made difficult to open. As a result, even when the stress acts in the direction of opening the joint 36 of the roller main body 31, the joint 36 can be prevented from opening, whereby it is possible to obtain the transport roller 13 capable of obtaining high transport accuracy.

Furthermore, the circumferential direction (bending direction) of the roller main body 31 is the same as the winding direction (a rolling direction of the large metallic plate 60) of the steel plate coil. For that reason, it is possible to match the bending direction of the large metallic plate 60 for molding the roller main body 31 with the bent direction due to the winding. As a result, the winding of the large metallic plate 60 for molding the roller main body 31 acts in a direction of closing the joint 36 of the roller main body 31. Thus, the opening of the joint 36 of the roller main body 31 can be more effectively prevented.

Finally, as shown in FIG. 12, the portion between the roller main body 31 and the connecting portion 63 is cut along a cut line G. In addition, in the state in which the roller main body 31 is molded, the convex portion 39 is fitted to the concave portion 40, but a predetermined gap 41 is formed between the front end portion 39a of the convex portion 39 and the bottom portion 40a of the concave portion 40. The gap 41 is provided so as to uniformly bring the first end surface 34 and the second end surface 35 into contact with each other. As described above, the molding of the roller main body 31 is completed by the progressive press machining (step S1).

Next, a known centerless polishing machining is performed with respect to the outer periphery surface of the roller main body 31 molded in the form of an approximate cylinder (step S2). By the polishing machining, the diameter, the roundness and the accuracy of flexure of the roller main body 31 is regulated to a suitable range.

Next, the plating treatment is carried out in the roller main body 31 (step S3). By the plating treatment, the plating layers 38 are formed on the inner and outer periphery surfaces of the roller main body 31, the first end surface inner edge portion 34b, and the second end surface inner edge portion 35b. In addition, even if the steel plate such as, for example, SECC in which the plating layer is formed in advance is used, the base material of the steel plate is exposed by the punching machining, so the first end surface 34 and the second end surface 35 easily corrode. Thus, it is necessary to form a suitable plating layer on the first end surface inner edge portion 34b and the second end surface inner edge portion 35b by this process.

Finally, the high frictional layer 32 is formed on the holding area F in the outer periphery surface 31a of the roller main body 31. Firstly, both end portions of the roller main body 31 are masked, epoxy-based resin or polyester-based resin is dispersed in the solvent, and the solution is applied to the outer periphery surface of the roller main body 31, thereby forming the resin layer. Next, the ceramics particles such as alumina particles are attached to the surface of the resin layer by the use of a powder coating method. Finally, the resin layer is cured by the heating treatment, whereby the high frictional layer 32 in which the ceramics particles are disposed at the surface is formed.

In addition, as a method of forming the high frictional layer 32, instead of the powder coating method, the ceramics particles may be dispersed in the solvent, thereby applying the solution onto the surface of the resin layer. Furthermore, the resin layer containing the ceramics particles may be formed by dispersing the ceramics particles in the solvent together with epoxy-based resin or polyester-based resin, thereby applying the solution onto the outer periphery surface of the roller main body 31.

The molding of the transport roller 13 is completed by the above-mentioned method.

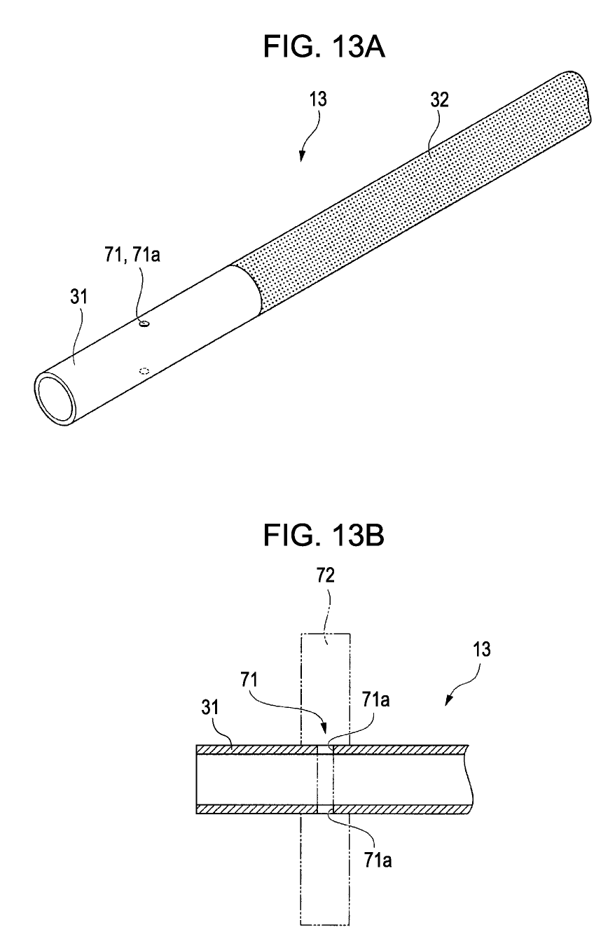

In addition, at both end portions of the roller main body 31 (the transport roller 13), at one side or both sides thereof as described above, an engagement portion for connecting to various connection components such as the first drive gear 23 or the third drive gear 25 shown in FIGS. 2A and 2B is formed. For example, as shown in FIGS. 13A and 13B, at mutually opposite positions of the roller main body 31 made of a cylindrical pipe (a hollow pipe), namely, at formed surfaces of two points which define the diameter of the roller main body 31, through holes 71a and 71a are respectively formed, whereby it is possible to form an engagement hole (an engagement portion) 71 including a pair of through holes 71a and 71a. With the engagement hole 71, the connection component 72 such as a toothed wheel can be fixed by a shaft or a pin (not shown).

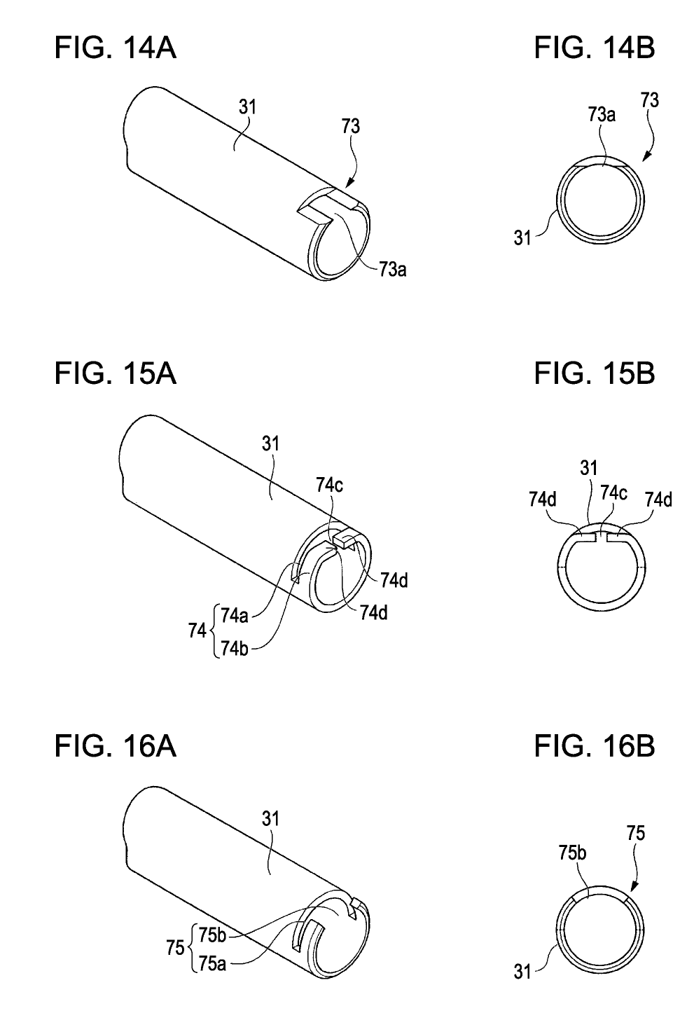

Furthermore, as shown in FIGS. 14A and 14B, a D cut-shaped engagement portion 73 may be formed at the end surface of the roller main body 31. The engagement portion 73 is formed at the end surface of the cylindrical hollow pipe (the roller main body 31) and has an opening 73a in which a portion thereof is recessed in a rectangular shape when seen from the plane, as shown in FIG. 14A, whereby, as shown in FIG. 14B, an outline of the end portion side is formed in the shape of a D in appearance.

Thus, by engaging the connection component such as the toothed wheel (not shown) with the engagement portion 73 formed in the form of a D in appearance, the connection component can be attached to the roller main body 31 (the transport roller 13) without drifting. Furthermore, in regard to the engagement portion 73, since the groove-shaped opening 73a communicating to the inner hole of the hollow pipe (the roller main body 31) is formed, even by the use of the opening 73a, the connection component can be attached to the roller main body 31 without drifting. Specifically, the convex portion is formed in the connection component, and the convex portion is fitted to the opening 73a, which makes it possible to prevent the drifting.

Furthermore, as shown in FIGS. 15A and 15B, an engagement portion 74 having a groove 74a and a D cut portion 74b may be formed at the end portion of the roller main body 31. In the engagement portion 74, the D cut portion 74b is formed at the end portion of the roller main body 31, and the groove 74a is formed at the inner part from the D cut portion 74b. As shown in FIG. 15A, the groove 74a is formed such that the roller main body 31 is approximately half-notched in the circumferential direction thereof. The D cut portion 74b has an opening 74c which extends in a direction perpendicular to the groove 74a at the outer side of the groove 74a, and has a pair of bending pieces 74d and 74d at both sides of the opening 74c. That is, as shown in FIG. 15B, the pair of bending pieces 74d and 74d is bent to the center axis side of the roller main body 31, whereby the portion corresponding to the bending pieces 74d and 74d is in the concave state from the circular outer periphery surface of the roller main body 31.

Thus, the connection component such as a toothed wheel (not shown) is engaged with the groove 74a or the D cut portion 74b, whereby the connection component can be attached to the roller main body 31 (the transport roller 31) without drifting. Moreover, in the engagement portion 74, even by the use of the opening 74c formed between the bending pieces 74d, the connection component can be attached to the roller main body 31 without drifting. Specifically, by forming the convex portion in the connection component and fitting the convex portion to the opening 74c, the drifting can be prevented.

Furthermore, as shown in FIGS. 16A and 16B, an engagement portion 75 having a groove 75a and an opening 75b may be formed at the end portion of the roller main body 31. In the engagement portion 75, the opening 75b is formed at an outer end of the roller main body 31, and the groove 75a is formed at the inner part from the opening 75b. As shown in FIG. 16A, the groove 75a is formed such that the roller main body 31 is approximately half-notched in the circumferential direction thereof. The opening 75b is configured such that a portion of the roller main body 31 is notched in the rectangular shape when seen from the plane at the outer side of the groove 75a, whereby the outline of the end portion side surface is formed in the shape of a D in appearance, as shown in FIG. 16B.

Thus, the connection component such as a toothed wheel (not shown) is engaged with the groove 75a or the part which is formed in the D shape in appearance formed by the opening 75b, whereby the connection component can be attached to the roller main body 31 (the transport roller 13) without drifting. Moreover, even in the engagement portion 75, in the same manner as the engagement portion 73 shown in FIGS. 14A and 14B, by the use of the opening 75b, the connection component can be attached to the roller main body 31 without drifting.

The engagement hole 71 or the engagement portions 73, 74 and 75 can be formed by carrying out the cutting machining or the like with respect to the roller main body 31 which has been obtained by bending the metallic plate 30. However, in that case, an addition of a separate machining process only to form the engagement portion with respect to the roller main body 31 lowers the efficiency regarding the cost or the time. Thus, in the production method of the present invention, before the roller main body 31 is molded by the bending machining (S13), a deploying engagement becoming the engagement portion is formed in the metallic plate 30 by the punching machining (S11), and then, when the roller main body 31 is molded by bending the metallic plate 30, the engagement portion is also concurrently formed.

Specifically, when the approximately narrow rectangular plate-shaped metallic plate 30 as shown in FIG. 7 is molded from the large metallic plate 60 as shown in FIG. 6, simultaneously with the machining from the large metallic plate 60 to the small metallic plate 30, at the end portion of the obtained metallic plate 30, the deploying engagement portion such as a recess shape, a protrusion shape, a hole shape, or a groove shape is formed.

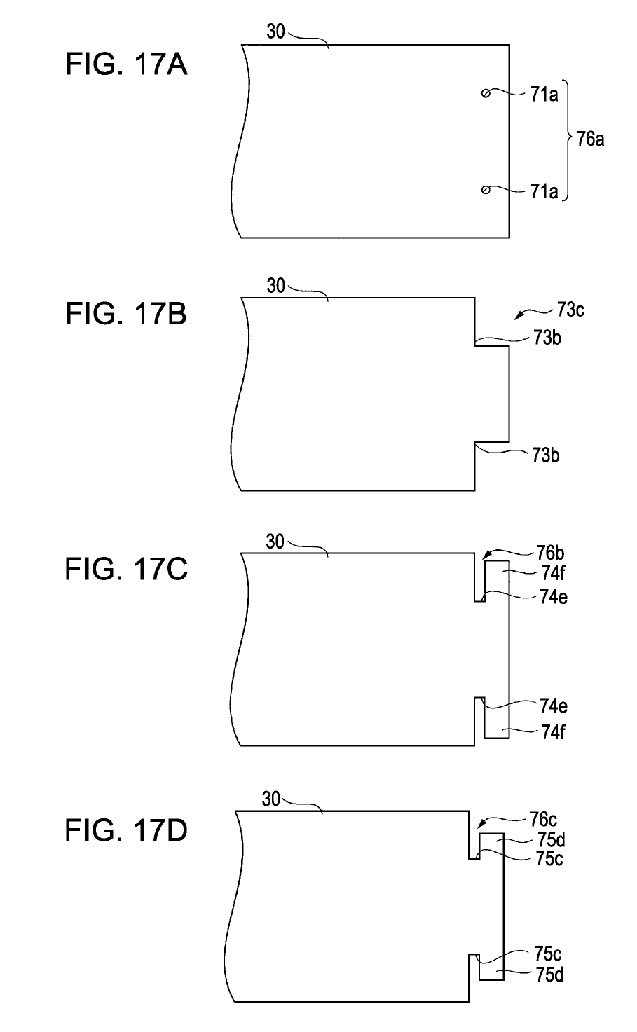

For example, as shown in FIG. 17A, a pair of through holes 71a and 71a is machined at a predetermined position of the metallic plate 30 and is set to be the deploying engagement portion 76a, whereby the pair of through holes 71a and 71a can be opposed to each other by bending the metallic plate 30, thereby forming the engagement hole 71 shown in FIGS. 13A and 13B.

Furthermore, as shown in FIG. 17B, the end portion of the metallic portion 30 is notched to a predetermined shape and is set to be the deploying engagement portion 73c including the pair of recess portions 73b and 73b, whereby the engagement portion 73 shown in FIG. 14 can be formed by bending the metallic plate 30.

In addition, as shown in FIG. 17C, the end portion of the metallic plate 30 is notched to a predetermined shape and is set to be the deploying engagement portion 76b, whereby the engagement portion 74 shown in FIG. 15 can be formed by bending the metallic plate 30. That is, by forming a pair of recess portions (the concave portions) 74e and 74e and a pair of protrusions 74f and 74f as the deploying engagement portion 76b, the engagement portion 74 can be formed. In the present embodiment, since after the metallic plate 30 is bent, it is necessary to bend the pair of protrusions 74f and 74f inside, to set them to be the bent piece 74d, it is slight insufficient for raising the efficiency in respect to the cost or the time regarding the machining process.

Thus, as shown in FIG. 17D, the end portion of the metallic plate 30 is notched to a predetermined shape and is set to be the deploying engagement portion 76c, whereby the engagement portion 75 shown in FIG. 16 can be formed by bending the metallic plate 30. That is, by forming a pair of recess portions (concave portions) 75c and 75c and a pair of protrusions 75d and 75d as the deploying engagement portion 76c, the engagement portion 75 can be formed. In the present embodiment, by also bending the pair of protrusions 75d and 75d in the form of a circular arc when the metallic plate 30 is bent, the opening 75b shown in FIG. 16B can be formed between the protrusions 75d and 75d. Thus, there is no need to add further machining with respect to the roller main body 31 formed by the bending machining, whereby it is possible to sufficiently improve the efficiency in the cost or the time regarding the machining process.

Herein, in the examples shown in FIGS. 17B to 17D, deploying engagement portions 73c, 76b and 76c are formed between both end portions of the metallic plate 30 so that the engagement portions 73, 74 and 75 shown in FIGS. 14, 15 and 16 are formed to pinch the joint 36 therebetween. In this manner, by forming the deploying engagement portions 73c, 76b and 76c at both end portions, the joint 36 of the roller main body 31 to be formed can be made shorter than the length of the roller main body 31. Thus, it is possible to suppress the deformation of the roller main body 31 due to the fact that the end surfaces 34 and 35 partially come into contact with each other and are disturbed when the joint 36 is formed.

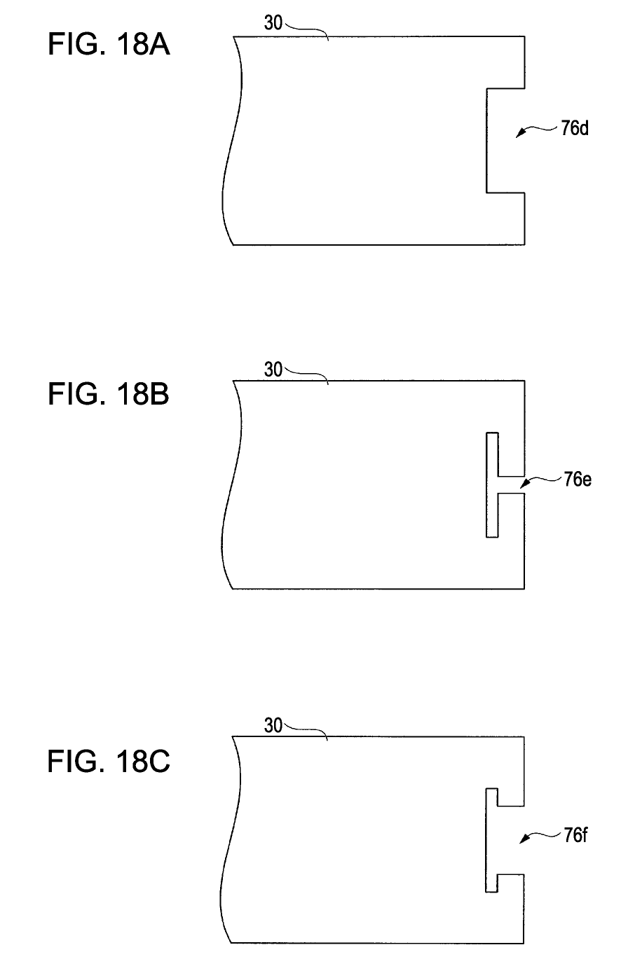

The present invention is not limited thereto, but, as shown in FIGS. 18A to 18C, the deploying engagement portion can be formed in the vicinity of the center line in the width direction (bending direction) without being formed at both end portions of the metallic plate 30. That is, as shown in FIG. 18A, by forming the deploying engagement portion 76d formed by the narrow rectangular recess portion at the end portion, the engagement portion 73 shown in FIGS. 14A and 14B can be formed. Furthermore, by forming a deploying engagement portion 76e formed by an approximately T-shaped cut-off portion as shown in FIG. 18B, the engagement portion 74 shown in FIGS. 15A and 15B can be formed, and by forming a deploying development portion 76f formed by the approximately T-shaped recess portion 76f as shown in FIG. 18C, the engagement portion 75 shown in FIGS. 16A and 16B can be formed.

In this manner, when the deploying engagement portions 76d to 76f are formed in the vicinity of the center line in the bending direction, it is possible to more accurately form the engagement portions 73 to 75 to be obtained from the deploying engagement portions 76d to 76f.

As described above, in the production method of the transport roller 13 of the present embodiment, when the small metallic plate 30 is molded by the punching machining from the large metallic plate 60, the deploying engagement portion is also concurrently formed, and when the metallic plate 30 is bent, the engagement portions 71, 73, 74 and 75 are formed from the deploying engagement portion. Thus, there is no need to add a separate machining process only for forming the engagement portion after the roller main body 31 is formed.

Thus, the cost or the time taken by the additional machining process is unnecessary, so that sufficient cost reduction in regard to the transport roller 13 itself is possible, whereby the productivity is also improved. Particularly, since the deploying engagement portion is collectively formed when the large metallic plate is miniaturized, the process can be further simplified.

Moreover, as shown in FIG. 12, in the transport roller 13 (the roller main body 31) according to the present embodiment, the joint 36 is formed so as to be parallel to the center axis of the roller main body 31 formed of a cylindrical hollow pipe. However, the present invention is not limited thereto, but, for example, on the straight line parallel to the center axis of the cylindrical pipe on the outer periphery surface of the cylindrical pipe (the roller main body), the joint, which is formed between the pair of end portions of the metallic plate 30 becoming the base material, may be formed so as to overlap only at one or a plurality of points without overlapping by a segment of line with respect to the straight line.

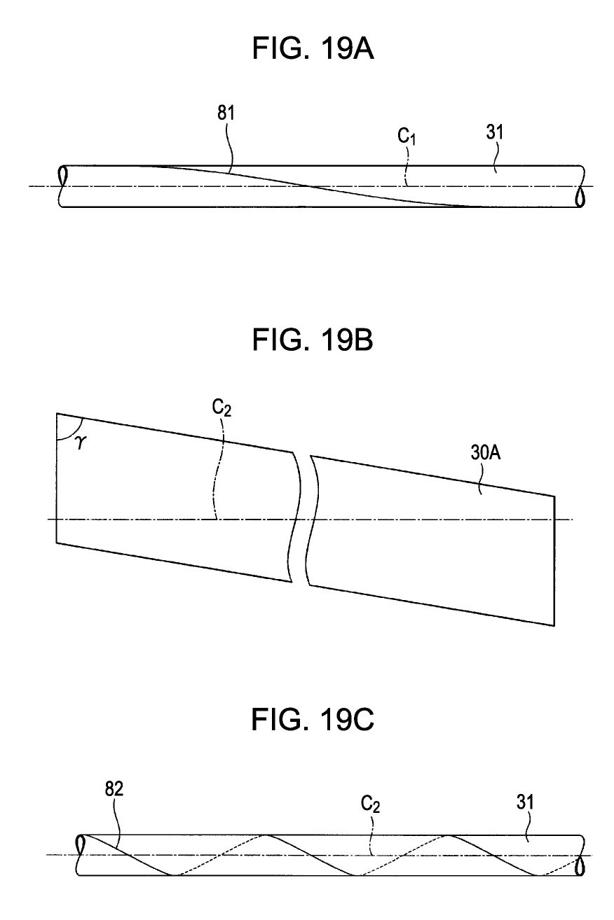

Specifically, as shown in FIG. 19A, as the joint 81, the outer periphery surface of the roller main body 31 may be formed so as to extend from an end of the roller main body 31 to the other end while extending in the circumferential direction so that it intersects the center axis C₁ of the roller main body 31 without being parallel thereto. In order to form the joint 81 in this manner, as the metallic plate becoming the base material, not by the use of the narrow rectangular metallic plate 30 as shown in FIG. 7, but by the use of the narrow parallelogram metallic plate 30A as shown in FIG. 19B, it is bent so that the straight line shown by reference numeral C₂ becomes the center axis. As a result, the roller main body 31 shown in FIG. 19A can be obtained, whereby the joint 81 is not parallel to the center axis C₁.

Furthermore, in the roller main body 31 shown in FIG. 19A, the joint 81 is formed so as to rotate around the periphery surface only by less than one revolution from one end of the roller main body 31 to the other end. This is to make the bending machining of the metallic plate 30A easier. However, the joint 82 as shown in FIG. 19C may be formed so as to rotate around the periphery surface from one end of the roller main body 31 to the other end by more than one revolution, that is, rotate in a spiral shape. In that case, an angle γ in the narrow parallelogram metallic plate 30A shown in FIG. 19B as the metallic plate becoming the base material may be an acute angle.

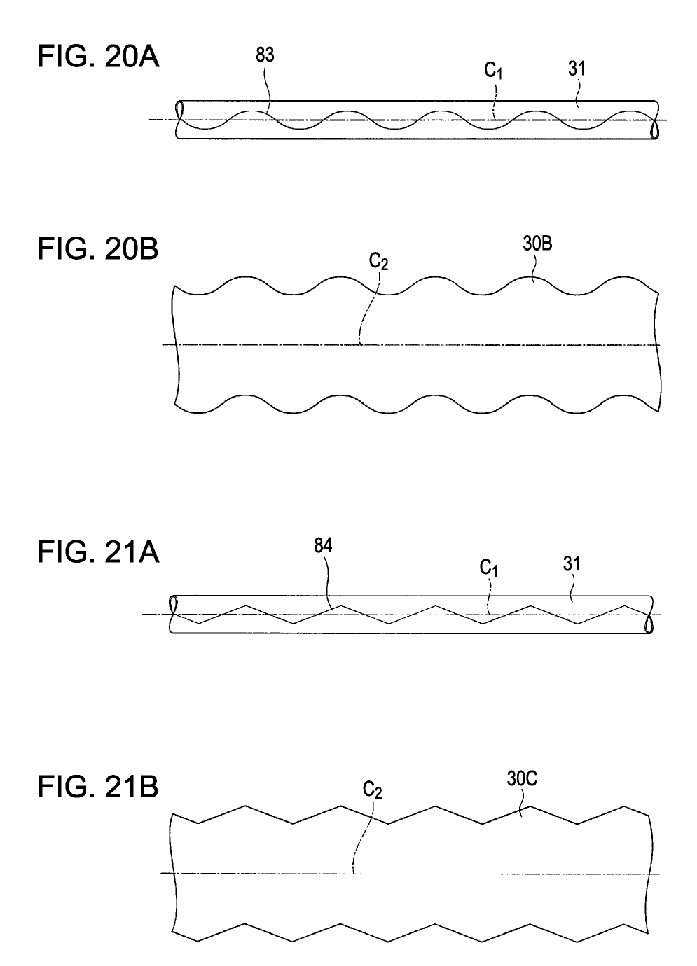

Moreover, as shown in FIG. 20A, the joint 83 may be formed in the form of a wave line formed by a curve such as a sine wave. In order to form the joint 83 in this manner, as shown in FIG. 20B, as the metallic plate becoming the base material, the metallic plate 30B, which has a narrow rectangular shape and in which both of long sides thereof are formed in the wave line shapes, is used and bent so that the straight line show by reference numeral C₂ becomes the center axis. In addition, since the pair of long sides formed in the shape of wave line are brought close to each other by the bending machining, naturally, between the places corresponding to each other, it is formed such that in a case where one long side becomes a mountain portion, the other long side becomes a valley portion, and, on the contrary, in a case where one long side becomes the valley portion, the other long side becomes the mountain portion. Furthermore, in the present embodiment, the center axis of the joint 83 is formed so as to be parallel to the center axis of the roller main body 31, but the center line of the joint 83 may also be formed so as not to be parallel to the center axis of the roller main body 31. In that case, as the metallic plate becoming the base material, the narrow parallelogram metallic plate as shown in FIG. 19B and a metallic plate in which both long sides are formed in the form of a wave line may be used.

Moreover, as shown in FIG. 21A, the joint 84 may be formed in the form of a wave line which is bent in a hook shape. In order to form the joint 84 in this manner, as the metallic plate becoming the base material, as shown in FIG. 19B, the metallic plate 30C, which has an approximately narrow rectangular shape and in which both long sides are formed in the wave line bent in a hook shape, is used and bent so that the straight line shown by reference numeral C₂ becomes the center axis.

Even in this metallic plate 30C, between the places corresponding to each other in the pair of long sides formed in the shape of a wave line, it is formed such that in a case where one long side becomes a mountain portion, the other long side becomes a valley portion, and, on the contrary, in a case where one long side becomes the valley portion, the other long side becomes the mountain portion. Furthermore, even in the present embodiment, the center line of the joint 84 is formed so as to be parallel to the center axis of the roller main body 31, but the center line of the joint 84 may also be formed so as not to be parallel to the center axis of the roller main body 31, in the same manner as the case of the joint 83.

Furthermore, in regard to the joint, various shapes can be adopted without being limited to the examples shown in FIGS. 19 to 21. For example, the wave line formed of the curve shown in FIG. 20A and the bent wave line shown in FIG. 21A may be combined, and the line having the inclination as shown in FIG. 19 may be combined therewith.

In this manner, when the joints 81 to 84 are formed so as to be overlapped only at one or plurality points without overlapping the segment of line in the line parallel to the center axis of the cylindrical pipe (the roller main body 31), when the transport roller 13 including the roller main body 31 transports the recording paper P in corporation with the driven roller 14, that is when transporting the paper, the transport speed of the recording paper P become regular, whereby the transport fluctuation is more securely prevented.

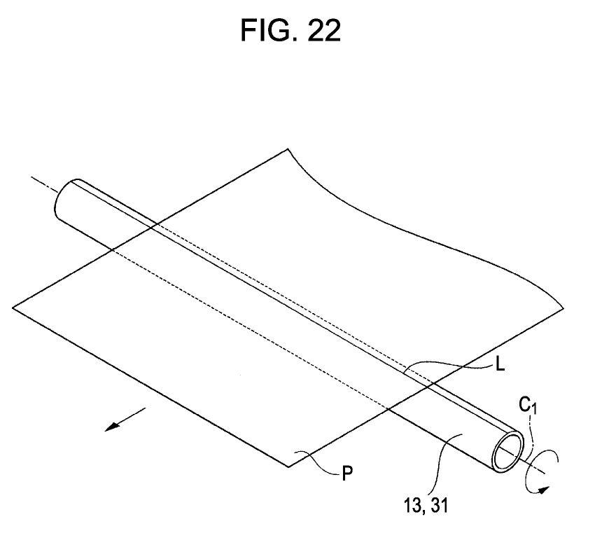

That is, as shown in FIG. 22, the place where the transport roller 13 comes into contact with the recording paper P when the paper is transported becomes, basically, a straight line L on the outer periphery surface thereof, i.e., a straight line L parallel to the center axis C₁. Thus, as shown in FIG. 12, in a case where the joint 36 of the transport roller 13 (the roller main body 31) is parallel to the center axis of the roller main body 31, the overall joint 36 of the transport roller 13 temporarily (momentarily) comes into contact with the recording paper P. Then, as described above, since the groove is not formed in the transport roller 13 of the present embodiment due to the joint 36, it is not an issue. However, if the groove is formed due to the joint 36, the groove temporarily and concurrently comes into contact with the joint 36, thus the overall width of the recording paper P temporarily comes into contact with the groove due to the joint 36. As a result, since a concave portion exists in the groove as compared to other outer periphery surfaces of the transport roller 13, and the contact resistance relative to the recording paper P is small, the transport speed of the recording paper P temporarily declines, thereby generating the transport fluctuation.

Firstly, as shown in FIGS. 19A, 19C, 20A and 21A, when the joints 81 to 84 are formed, even if the grooves are formed due to the joints, places where the grooves concurrently come into contact with the recording paper P when the paper is transported become only one or a plurality of points. Thus, as compared to when other surfaces (lines) of the transport roller 13 correspond, the contact resistance hardly changes, whereby the transport speed of the recording paper P becomes regular and the transport fluctuation is prevented.

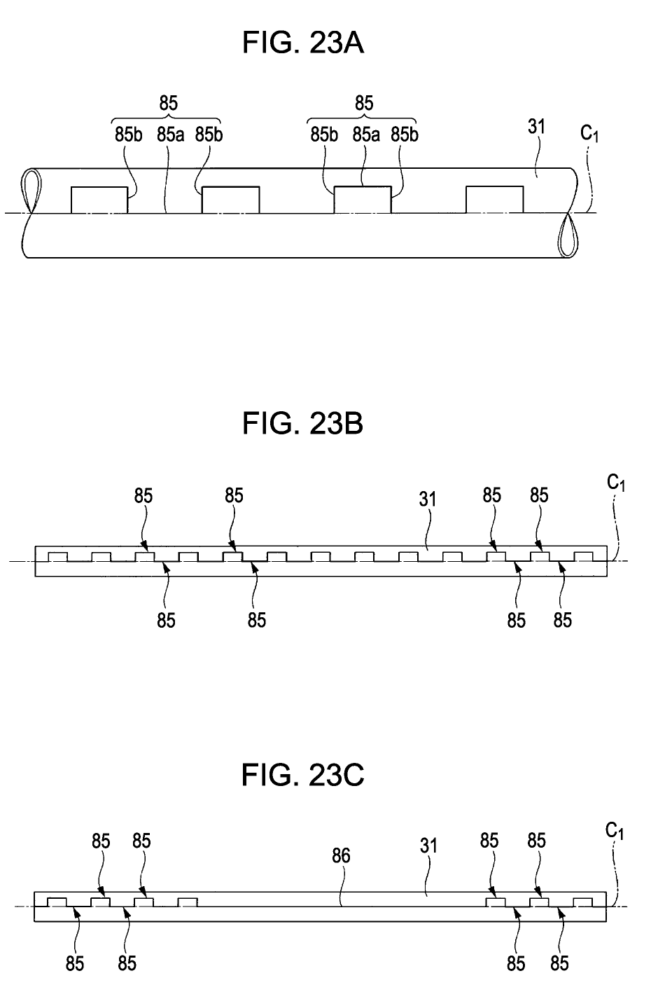

Furthermore, in regard to the joint of the transport roller 13 (the roller main body 31) formed of a cylindrical hollow pipe, in addition to the above-mentioned example, for example, as shown in FIG. 23A, it may be formed so as to have a rectangular wave-shaped bent portion 85 including a straight line portion 85a parallel to the center axis of the roller main body 31 and a straight line portion 85b perpendicular thereto. Even in the joint having the bent portion 85, in a case where the groove is formed due to the joint, since the groove does not concurrently come into contact with the overall width of the recording paper P when the paper is transported, the transport speed of the recording paper P is almost regular, whereby the transport fluctuation is prevented.

Furthermore, the bent portions 85 may be formed all over the length of the roller main body 31 as shown in FIG. 23B and may be selectively formed at both end portions except for the center portion thereof, as shown in FIG. 23C. As shown in FIG. 23C, when the bent portion 85 are formed only at both end portions, a portion between the bent portions 85 becomes a middle straight line portion 86 parallel to the center axis of the roller main body 31. Although it is not shown, the middle straight line portion between the bent portions 85 may be formed as an oblique line which is not parallel to the center axis C₁ as shown in FIG. 19A.

Furthermore, when the bent portions 85 are formed only at both end portions as described above and the center portion between the bent portions 85 is formed as the middle straight line portion 86, it is desirable that the forming area of the high frictional layer 32 shown in FIGS. 3A and 3B correspond to the middle straight line portion 86.

When the bent portions 85 are formed in the joint, so that the bent portions 85 are made to be the fitting portion by the concave and convex portions, it is difficult to fit the concave and convex portions as designed in the bent portions 85 (fitting portions) and bring the front end of the convex portion and the concave portion corresponding thereto into contact with each other (face to face) without a gap therebetween. Thus, when the bent portions 85 are formed all over the length of the roller main body 31, deformation or the distortion is easily generated in the roller main body 31. Therefore, as shown in FIG. 23C, when the bent portions 85 are formed only at both ends, it is possible to suppress the deformation or the distortion from being generated. Furthermore, particularly, by making the center portion corresponding to the high frictional layer 32, which becomes the area directly contacting the recording paper P, be the middle straight line portion 86 but not the bent portions 85, it is possible to reliably prevent the deformation or the distortion from being generated in the area that directly contacts the recording paper P.

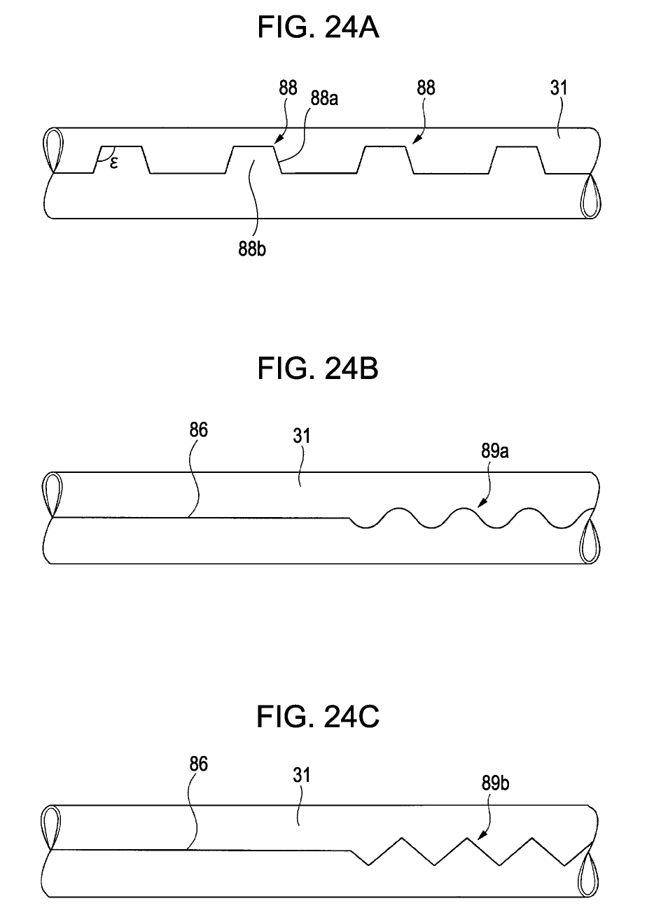

In addition, in regard to the joint of the transport roller 13 (the roller main body 31) formed of a cylindrical hollow pipe, in addition to the above-mentioned example, for example, as shown in FIG. 24A, an intersecting portion 88a in the bent portion 88 is not parallel to the center axis of the roller main body 31, so that the angle ε of a front end side a convex piece 88b in the bent portion 88 may be formed to be an obtuse angle (less than 180°). In this way, when a pair of end surfaces are brought into contact with each other in the bending machining of the metallic plate, it is easy to fit the front end of the convex piece 88b into the corresponding concave portion, so that it is possible to suppress the distortion or the deformation from being generated in the roller main body 31.

Furthermore, in a configuration in which the bent portions 85 are formed only in both end portions as shown in FIG. 23C, for example, the bent portions 85 may be altered to a wave line 89a formed of a curved line shown in FIG. 20A, as shown in FIG. 24B, and may be altered to a bent wave line 89b shown in FIG. 21A, as shown in FIG. 24C.

Furthermore, rectangular wave-shaped bent portions 85 shown in FIG. 23A and the wave lines 89a formed by the curved lines shown in FIG. 24B may be combined with each other to form the joint, and the rectangular wave-shaped bent portions 85 and the bent wave lines 89b shown in FIG. 24C may be combined with each other to form the joint.

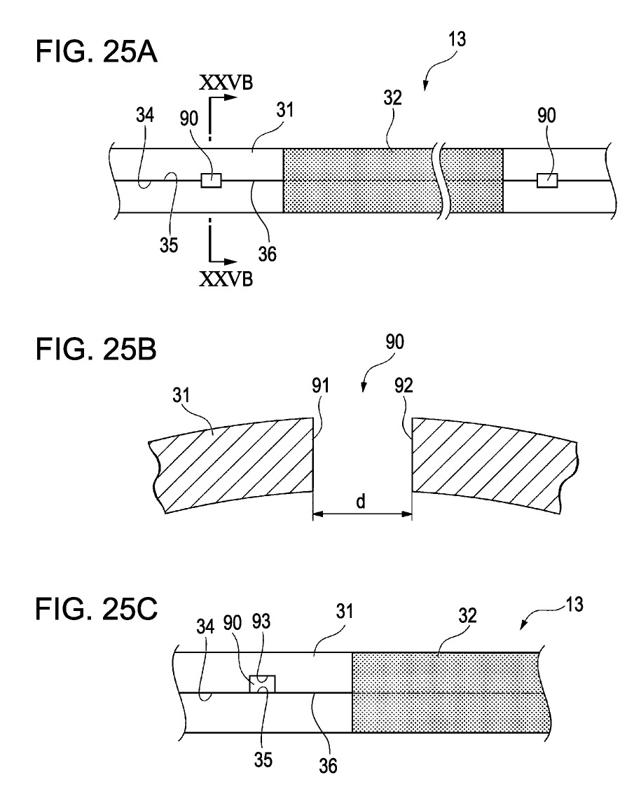

Moreover, as shown in FIG. 25A, in the transport roller 13, openings 90 may be provided on a part of the joint 36 formed in the roller main body 31.

Since the joint 36 is formed all over the length of the roller main body 31, when grease, which has been supplied to a bearing (not shown) for rotatably supporting the transport roller 13, is attached to the surface of the transport roller 13, the grease passes and flows on the joint 36 due to a capillary phenomenon. Particularly, the smaller the gap between the end surfaces 34 and 35 in the joint 36 to improve the strength of the transport roller 13 is, the stronger the capillary phenomenon of the grease, whereby the grease easily flows along the joint 36.

Thus, as shown in FIG. 25B, the openings 90 are provided on a part of the joint 36 formed in the roller main body 31. The openings 90 are formed by the recess portions 91 and 92 which are respectively provided on the pair of end surfaces 34 and 35 forming the joint 36. When the end surfaces 34 and 35 are made face to face, a maximum distance d between the recess portions 91 and 92 is set so as to be, for example, equal to or greater than about 1 mm, thereby serving as the openings 90.

The openings 90 are provided on an area except for the area with the high frictional layer 32 formed thereon and the area supported by the bearing, in the joint 36 formed all over the length of the transport roller 13 (the roller main body 31). That is, the high frictional layer 32 is formed at a nearly center portion of the transport roller 13 and the both end sides of the transport roller 13 are supported by the bearing, thus at least two openings 90 are provided on the transport roller 13.

The openings 90 are provided with a view to preventing the grease (a lubricant oil), which has been supplied (applied) to the bearing, from reaching up to the high frictional layer 32 along the joint 36 (the gap between the end surfaces 34 and 35). That is, by providing the openings 90 on a part of the joint 36, the capillary phenomenon of the grease is stopped. Specifically, by providing the opening 90 between the area supported by the bearing and the area with the high frictional layer 32 formed thereon in the joint 36, the grease is prevented from reaching the high frictional layer 32. In addition, by regulating the size (a maximum distance d between the pair of recess portions 91 and 92) of the opening 90, the capillary phenomenon of the grease can be reliably stopped.

In addition, the invention is not limited to a case of forming the recess portions 91 and 92 for forming the openings 90 in each of the pair of end surface 34 and 35 forming the joint 36. That is, as shown in FIG. 25C, it may be a case where a recess portion 93 is formed in only one (e.g., end surface 34) of the pair of end surfaces 34 and 35 forming the joint 36, whereby the opening 90 is formed by the recess portion 93 and the end surface 35. Moreover, the shape of the opening 90 is not limited to the rectangular shape but it may be a circular shape or the like.

Next, an operation of the printer 1 relating to the present embodiment will be described based on FIGS. 1 to 3.

As shown in FIGS. 1 and 2, the recording paper P mounted on the paper tray 11 is supplied toward the transport portion 3 by the rotation of the paper feeding roller 12 in the paper feeding portion 2. The transport roller 13 rotates by the operation of the drive portion 6. Furthermore, the driven roller 14, which is provided to contact the outer periphery surface of the transport roller 13, rotates in a direction contrary to the transport roller 13. The recording paper P supplied from the paper feeding portion 2 is pinched between the transport roller 13 and the driven roller 14, and the high frictional layer 32 is formed at the holding area F of the transport roller 13, thus the recording paper P is held in the transport roller 13. Accordingly, the recording paper P is accurately transported together with the rotation of the transport roller 13.

Herein, as shown in FIG. 3, the first end surface outer edge portion 34a and the second end surface outer edge portion 35a are in contact with each other at the outer periphery surface 31a side, whereby the gap, the concave portion or the like, which opens to the outer periphery surface 31a side, does not exist in the joint 36. For this reason, even if the transport roller 13 rotates, the outer periphery surface 31a can always be in contact with the recording paper P. Thus, the slippage or the like is not generated between the outer periphery surface 31a and the recording paper P, whereby the recording paper P can be transported at a high accuracy.

By the rotation of the transport roller 13, the recording paper P is transported to the top surface of the diamond rib 16 in the platen 15. The ink is ejected from the ejection head 19, which has been moved to a suitable position along with the carriage 20, with respect to the recording paper P mounted on the diamond rib 16, so that information such as letters or images is printed. After the printing, the recording paper P is discharged by the rotation of the paper discharge roller 17 and the paper discharging coarse roller 18 of the paper discharge portion 4.

In this manner, the operation of the printer 1 according to the present embodiment is completed.

Thus, according to the present embodiment, the following effect can be obtained.

According to the present embodiment, there is an effect in that even when the transport roller 13, in which the metallic plate 30 is subjected to bending machining so as to be molded in the form of a cylinder, is used to transport the recording paper P, the holding of the recording paper P by the transport roller 13 is always maintained, whereby the recording paper P can be transported and positioned at a high accuracy.

Although preferable embodiments relating to the present invention have been described with reference to the attached drawings, it is needless to say that the present invention is not limited to the related embodiments. The shapes or the combinations of the respective components shown in the above-mentioned example are an example, and can be variously altered in the scope, which does not depart from the gist of the present invention, on the basis of the design requirements or the like.

What is claimed is:

1. A print device including a transport roller for transporting a recording medium in which a pair of end surfaces of a metallic plate faces each other so as to be molded in a cylindrical shape,
wherein at least one end surface of the pair of end surfaces includes a first portion which comes into plane contact with the other end surface of the pair of end surfaces at an outer periphery surface side of the transport roller, and a second portion which has a gap between the second portion and the other end surface at an inner periphery surface side thereof.

2. The print device according to claim 1, wherein the pair of end surfaces include the first portion and the second portion, and wherein an angle formed by the second portion and the inner periphery surface is greater than 90° in any end surface.

3. The print device according to claim 1, wherein only one end surface includes the first portion and the second portion, and wherein the angle formed by the second portion and the inner periphery surface is greater than 90°.

4. The print device according to claim 1,
Wherein, in a direction perpendicular to the end surface, the first portion in the sectional surface of the metallic plate, is shorter than the second portion in the sectional surface thereof.

5. The print device according to claim 1,
wherein the first portion and the second portion are provided at least on a place that corresponds to a holding area of the recording medium in the transport roller.

6. A transport unit including a transport roller in which a pair of end surfaces of a metallic plate faces each other so as to be molded in a cylindrical shape,
wherein at least one end surface of the pair of end surfaces includes a first portion which comes into plane contact with the other end surface of the pair of end surfaces at an outer periphery surface side of the transport roller, and a second portion which has a gap between the second portion and the other end surface at an inner periphery surface side thereof.

7. A transport roller in which a pair of end surfaces of a metallic plate faces each other so as to be molded in a cylindrical shape,
wherein at least one end surface of the pair of end surfaces includes a first portion which comes into plane contact with the other end surface of the pair of end surfaces at an outer periphery surface side, and a second portion which has a gap between the second portion and the other end surface at an inner periphery surface side.

8. A method of producing a transport roller in which a pair of end surfaces of a metallic plate faces each other so as to be molded in a cylindrical shape comprising the steps of:
forming a first portion which is connected to a one plate surface in a plate thickness direction of the metallic plate in at least one end surface of a pair of end surfaces, and a second portion which is connected to the other plate surface of an opposite side of the one plate surface and is different from the first portion; and
bending the metallic plate so that the one plate surface becomes an outer periphery surface, thereby molding the metallic plate in a cylindrical shape,
wherein, in the step of bending, the first portion is brought into plane contact with the other end surface of the pair of end surfaces, and a gap is formed between the second portion and the other end surface.

9. The method according to claim 8,
wherein, in the step of forming the first portion and the second portion are formed in the pair of end surfaces, and an angle formed by the second portion and the other plate surface is greater than 90° in any end surface.

10. The method according to claim 8,
wherein, in the step of forming, the first portion and the second portion are formed in only the one end surface, and an angle formed by the second portion and the other plate surface is greater than 90°.

11. The method according to claim 8,
wherein, in the step of forming, in a direction perpendicular to the end surface, the first portion in the sectional surface of the metallic plate is formed so as to be shorter than the second portion in the sectional surface.

12. The method according to claim 8,
wherein, in the step of forming, the first portion and the second portion are formed at least on a place of the end surface that corresponds to a holding area of the recording medium in the transport roller.
